(19) United States
(12) Patent Application Publication
(10) Pub. No.: US 2024/0054444 A1
(43) Pub. Date: Feb. 15, 2024

(54) LOGISTICS SCHEDULING METHOD AND SYSTEM FOR INDUSTRIAL PARK BASED ON GAME THEORY

(71) Applicant: INSTITUTE OF INDUSTRIAL INTERNET, CHONGQING UNIVERSITY OF POSTS AND TELECOMMUNICATIONS, Chongqing (CN)

(72) Inventors: Junhua Chen, Chongqing (CN); Jiatong Zhang, Chongqing (CN); Ran Liu, Chongqing (CN); Xueda Huang, Chongqing (CN); Fenghao Si, Chongqing (CN); Haohong Ran, Chongqing (CN)

(21) Appl. No.: 18/493,598

(22) Filed: Oct. 24, 2023

Related U.S. Application Data
(63) Continuation of application No. PCT/CN2022/091540, filed on May 7, 2022.

(30) Foreign Application Priority Data
Jun. 18, 2021 (CN) 202110680025.0

(51) Int. Cl. G06Q 10/0835; G06Q 10/047; G06Q 10/0631; G06Q 10/0834

(52) U.S. Cl. CPC G06Q 10/08355; G06Q 10/047; G06Q 10/0631; G06Q 10/08345

(57) ABSTRACT

Disclosed is a logistics scheduling method and system for an industrial park based on a game theory. The method includes the following steps: establishing a logistics scheduling task model based on the game theory according to a relationship between warehouses and freight vehicles in logistics tasks; constructing an optimal decision model of each freight vehicle to maximize transportation income; constructing an optimal decision model of each warehouse to maximize warehousing income; and solving the optimal decision model of the freight vehicle to obtain an optimal decision for logistics scheduling. According to the present disclosure, the transportation efficiency is obviously improved, an empty return rate is reduced, and the real-time performance of the logistics tasks is not affected.

### CROSS-REFERENCE TO RELATED APPLICATIONS

This application is a continuation of PCT/CN2022/091540, filed May 7, 2022 and claims priority of Chinese Patent Application No. 202110680025.0, filed on Jun. 18, 2021, the entire contents of which are incorporated herein by reference.

### TECHNICAL FIELD

The present disclosure belongs to the technical field of logistics technology and edge computing, and provides a logistics scheduling method and system for an industrial park based on a game theory.

### BACKGROUND

Logistics is a process in which the functions of transportation, storage, loading and unloading, packaging, circulation processing, distribution and information processing are organically combined to meet the demands of users during the physical flow of goods from a supplier to a receiver according to actual needs. At present, freight scheduling modes between warehouses and warehouses, warehouses and production lines, production lines and production lines in an industrial park are single, and a traditional freight scheduling mode has some problems such as low efficiency and high empty-loading rate. In the prior art, the most common mode is that the users upload multiple logistics distribution requests through user terminals, and after management staff of a logistics department receive the logistics distribution requests, transportation vehicles in the company are manually scheduled to respond to the logistics distribution requests of the users, so that a processing speed is slow and the efficiency is low, thereby causing a low scheduling efficiency.

With the development of mobile edge computing technology, the transportation efficiency can be effectively improved by real-time analysis of freight relations. When the mass and volume of transported goods are much smaller than the load of freight vehicles, simple scheduling methods are likely to cause waste of resources, and multi-batch transportation even causes congestion during transportation. In industrial scenes, the transportation among multiple production lines is more complicated. The scheduling efficiency can be effectively improved by planning an optimal route scheme for the transported vehicles. How to establish a suitable scheduling model and quantify the scheduling efficiency by combining the data analysis ability of mobile edge computing is of great significance to the logistics management and transportation in the industrial park.

### SUMMARY

Based on existing problems in the prior art, the present disclosure provides a logistics scheduling method and system for an industrial park based on a game theory, which utilizes a unified system platform to manage goods warehousing information and information in the transportation process, to realize the functions of users' tasks initiation or acceptance, task inquiry, and task tracing. A model is established for two freight parties according to a Stackelberg game theory to provide optimal pricing and freight volume decision schemes. In order to solve the problems such as insufficient computation of the freight vehicles in the industrial park, a mobile edge computing node is constructed to compute an optimal decision scheme for the freight vehicles and plan transportation routes. Compared with a traditional logistics management system, according to the scheme, the transportation efficiency is significantly improved, an empty return rate is reduced, the real-time performance of tasks is not affected, and the real-time performance of task delivery is even improved to some extent. The present disclosure has good practical significance and application value.

In order to achieve the above object, the present disclosure provides the following technical solutions.

In a first aspect of the present disclosure, a logistics scheduling method for an industrial park based on a game theory is provided, the method including the following steps:

modeling warehouses and freight vehicles by a Stackelberg game model according to a relationship between the warehouses and the freight vehicles in logistics tasks, and establishing a logistics scheduling task model according to attributes of the logistics tasks;

solving transportation income of the freight vehicles and warehousing income of the warehouses corresponding to the logistics tasks under various decisions according to a task decision basis in the logistics scheduling task model,

constructing an optimal decision model of each freight vehicle to maximize the transportation income, and constructing an optimal decision model of each warehouse to maximize the warehousing income; and

solving the optimal decision model of the freight vehicle according to a gradient descent method, outputting a solution result to the optimal decision model of the warehouse, and iterating two optimal decision models until a preset threshold is reached to obtain optimal decisions of the freight vehicles and the warehouses for logistics scheduling, i.e., decision results of Nash equilibrium.

In a second aspect of the present disclosure, a logistics scheduling system for an industrial park based on a game theory is provided, including road side units (RSU), on-board units (OBU), mobile edge computing servers (MEC), a database and an application platform. The road side unit is configured to locate and provide basic communication support for warehouses and transportation vehicles; the mobile edge server is configured to provide computing support for a transaction process to realize a logistics scheduling method for an industrial park based on a game theory according to the first aspect of the present disclosure; and the database and the application platforms are configured to record task transaction information and broadcast task requests.

Specifically, task participants register accounts through the application platform, and each task request will be broadcast to other accounts through the account with the help of the mobile edge server; the mobile edge server computes the Nash equilibrium between the task model and each service node, a sequence table is obtained according to the descending order of task request income and continuously updated before the task starts; the sequence table is a priority list of transaction objects of the task, and the top one has the higher priority of participating in the transaction; and finally, the whole task process is recorded in the database, which is convenient for task query and information tracing.

The present disclosure has the following beneficial effects.

The present disclosure provides a logistics scheduling method and system for an industrial park based on a game theory, aiming at the goods scheduling management technology between warehouses and warehouses, warehouses and production lines, production lines and production lines in the industrial park, to manage goods warehousing information and information in the transportation process. At the same time, optimal decision schemes are provided for two freight parties and lowest-cost transportation routes are chosen for the freight vehicles. Compared with the traditional logistics management system, according to the present disclosure, the transportation efficiency is significantly improved, the empty return rate is reduced, the real-time performance of the logistics task is not affected, and the real-time performance of task delivery is even improved to some extent. The present disclosure has good practical significance and application value.

### BRIEF DESCRIPTION OF THE DRAWINGS

In order to make the purpose, technical solutions and beneficial effects of the present disclosure more clear, the present disclosure provides the following attached drawings for explanation.

FIG. 1 is a flow chart of a logistics scheduling method for an industrial park based on a game theory according to an example of the present disclosure;

FIG. 2 is a model diagram of logistics scheduling tasks according to an example of the present disclosure;

FIG. 3 is a flow chart of a task request according to an example of the present disclosure;

FIG. 4 is a flowchart of task service according to an example of the present disclosure; and

FIG. 5 is a flowchart of strategy analysis after a mobile edge node receives a task according to an example of the present disclosure.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. Based on the examples in the present disclosure, all other examples obtained by those of ordinary skill in the art without creative efforts belong to the scope of protection of the present disclosure.

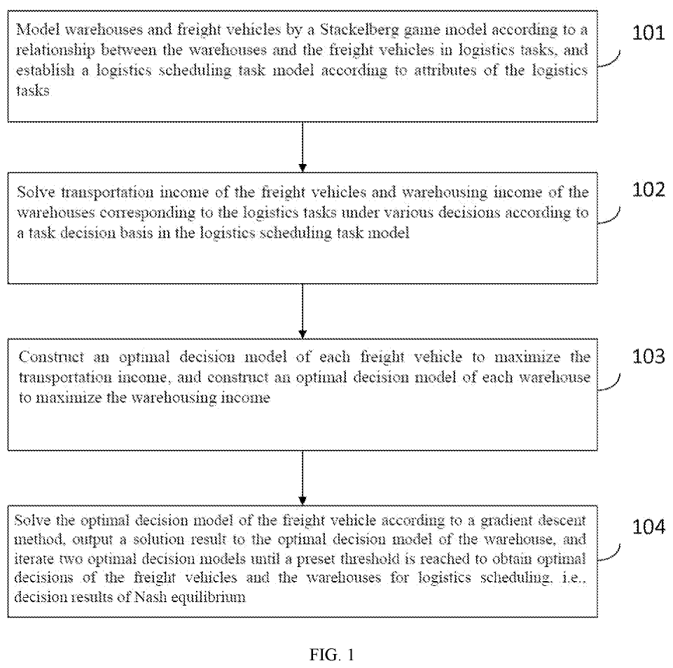

FIG. 1 is a flow chart of a logistics scheduling method for an industrial park based on a game theory according to an example of the present disclosure. As shown in FIG. 1, the scheduling method includes the following steps.

At 101: warehouses and freight vehicles are modeled by a Stackelberg game model according to a relationship between the warehouses and the freight vehicles in logistics tasks, and a logistics scheduling task model is established according to attributes of the logistics tasks.

Goods resources need to be transported from suppliers to warehouses, sorted and classified, and transported to production lines of several factories for processing. Finally, finished products are transported to dealers. For each one of transportation tasks, considering the pricing relationship between the warehouse as a requesting party and the freight vehicle as a serving party, the freight vehicles need higher pricing to obtain greater benefits, while the warehouses need lower pricing to obtain greater benefits. According to the present disclosure, the requesting party and the serving party are taken as two parties of the game, and the two parties are modeled according to the Stackelberg game; and a task initiator (a requesting party) is a leader of Stackelberg game, and a task receiver (a serving party) is a follower of Stackelberg game.

The attributes of logistics tasks at least include the mass of goods, the maximum transportation time limited to complete the task, and transportation price.

At 102: transportation income of the freight vehicles and warehousing income of the warehouses corresponding to the logistics tasks under various decisions are solved according to a task decision basis in the logistics scheduling task model.

As the leader of Stackelberg game, the requesting party makes a pricing strategy {λ=[λᵢ]i ∈E N: λₘᵢₙ<λᵢ} for this batch of goods as a service fee, λₘᵢₙ being the lowest pricing and N is the total number of tasks; assuming that the total amount of freight goods this time is m, the income generated by transporting each unit of goods to the warehouse is recorded as R.

In addition, the task requesting party prefers the cooperated serving party with high reputation, which can be defined as the subjective preference co of the warehouse; therefore, the warehousing income of the warehouses can be expressed as:

U_{c}=(R μᵢ−λᵢ) ω.

In the above example, the present disclosure considers the timeliness and safety in the task decision process. For the industrial park, the requesting party prefers the cooperated freight vehicle with good delivery records. The multi-weight subjective preferences are subdivided, including familiarity weight, time weight and similarity weight.

The familiarity weight is defined as xᵢ^{j}, representing a relationship frequency between the warehouse i and the freight vehicle j, and a task handover frequency is proportional to the familiarity weight. The familiarity weight between the freight vehicle j and the warehouse i can be defined as:

$${x}_{i}^{j} = \frac{{f}_{( i , j )}}{\frac{1}{\vert N \vert} \sum n ∈ Nf ( i , n )}$$

ƒ_{(i,j)} representing the number of transactions between a current warehouse i and the freight vehicle j; ƒ_{(i,n)} representing the number of transactions between the current warehouse i and the freight vehicle n; and N being the total number of freight vehicles. ƒ is represented as a two-dimensional array stored in the database, and a value of ƒ[i] [j] will be accurately queried every transaction, and brought into the above formula to solve the familiarity weight of the freight vehicle corresponding to the current task.

The time weight is recorded as yᵢ^{j}, and the time stamp of the current time is recorded as t. If the task relationship between a freight vehicle j and a warehouse i is a recent event, then the freight vehicle j will have a greater impact on the warehouse i, and vice versa. The time weight between the freight vehicle and the warehouse can be defined as:

yᵢ^{j}=α₁(tᵢ^{j}−t)^{αdi 2}

α₁ and α₂ being parameters used to indicate the influence of time, tᵢ^{j} representing the latest time of the task relationship between freight vehicle j and warehouse i, and the transaction time of a more recent task being also recorded in an ƒ array, where 0<α₁<1, α₂>1.

The similarity weight is recorded as zᵢ^{j}, according to locations lⱼ and lᵢ of the warehouse and the freight vehicle, the closer distance can not only reduce the transportation expenses, but the requesting party also prefers to initiate transactions with other serving parties nearby. The similarity weights between freight vehicles and warehouses can be defined as:

$${z}_{i}^{j} = \frac{1}{1 + \vert {l}_{i}^{a} - {l}_{j}^{a} \vert}$$

lᵢ^{α}and lⱼ^{α} representing locations of the warehouse i and the freight vehicle j, the location lⱼ^{α} of the freight vehicle j being represented as a parking lot location without tasks, and data information needing to be updated if changes occur.

Comprehensively considering the familiarity weight, time weight and similarity weight, the subjective preferences of the current warehouse for freight vehicles can be obtained, ω=γ₁xᵢ^{j}+γ₂yᵢ^{j}+γ₃zᵢ^{j}, where γ₁+γ₂+γ₃=1; and γ₁ represents the first weight, i.e., familiarity weight, γ₂ represents the second weight i. e. , similarity weight, and γ₃ represents the third weight, i. e. , time weight. The values of these weights can be given according to the prior art.

As the follower of Stackelberg game, the freight vehicles formulate freight volume strategies and determine utility functions. The utility function of each freight vehicle is analyzed, and its strategy is defined as freight volume μᵢ, {=[μᵢ]i ∈N: 0μᵢ<M}, and the cost of unit mileage in the freight process includes fuel and loss and is marked as c, the distance from the starting point to the end point is marked as sᵢ, and M is the maximum cargo capacity of the freight vehicle.

Therefore, the transportation income Uₛ of the freight vehicles can be expressed as:

a plurality of freight vehicles are required to cooperate to complete a task if carrying capacity M of a current freight vehicle is less than freight volume m of a warehouse,

the transportation income of the freight vehicles can be expressed as:

Uₛ=μᵢλᵢ−sᵢc−β(μᵢW)²;

if the carrying capacity M of the current freight vehicle is greater than freight volume m of a warehouse, a plurality of warehouses are served by the freight vehicle at the same time to improve its own income,

therefore, the transportation income of the freight vehicles can also be expressed as:

$${U}_{s} = {\sum }_{i ∈ Φ}^{Φ} {μ}_{i} {λ}_{i} - {\sum }_{i ∈ Φ}^{Φ} {s}_{i} c - {β ( {\sum }_{i ∈ Φ}^{Φ} {μ}_{i} W )}^{2}$$

β being a state-related parameter that indicates a ratio of current workload to maximum bearing workload, 0<β≤1, W being a depreciation rate of the freight vehicle during transportation, and Φ representing the number of tasks that the current freight vehicle needs to perform.

At 103: an optimal decision model of each freight vehicle is constructed to maximize the transportation income, and an optimal decision model of each warehouse is constructed to maximize the warehousing income.

In order to maximize the warehousing income, because R is a fixed value for a specific warehouse, the freight volume μᵢ is required to be maximum and the pricing λᵢ to be minimum.

In order to maximize the transportation income, because W is a fixed value for a specific freight vehicle, the transportation income depends on the freight volume μᵢ, the pricing λᵢ and the distance sᵢ from the starting point to the end point.

Based on the above analysis, the optimal decision model of each freight vehicle and the optimal decision model of each warehouse are expressed as follows:

$${λ}_{i}^{*} = arg {max}_{{λ}_{i}} \{ {U}_{c} ( {λ}_{i} , R ) \}$$

$${μ}_{i}^{*} = arg {max}_{{μ}_{i}} \{ {U}_{s} ( {μ}_{i} , {λ}_{i} , {s}_{i} \}$$

λ*ᵢ representing the optimal freight volume decision for freight vehicles to perform tasks i; and μ*ᵢ representing the optimal pricing decision for freight vehicles to perform tasks i.

At 104: the optimal decision model of the freight vehicle is solved according to a gradient descent method, a solution result is outputted to the optimal decision model of the warehouse, and two optimal decision models are iterated until a preset threshold is reached to obtain optimal decisions of the freight vehicles and the warehouses for logistics scheduling, i.e., decision results of Nash equilibrium.

Through the logistics task scheduling model, it can be found that the utility function and decision variables present characteristics of a convex function, that is, the single sub-game has a local optimal solution, and the process from local optimal to global optimal is the solution process of Nash equilibrium, which is the decision result computed by the optimal decision model.

In order to prove the existence and uniqueness of Nash equilibrium, the following analysis is made on variables λ and μ of the utility function (income function) of two parties. Firstly, the local optimization of the sub-game is solved, and according to the characteristics of the convex function, μ* is solved when a first derivative of the utility function is 0, that is:

$${μ}^{*} = \frac{λ - sc}{2 β {W}^{2}} m > M ;$$

$${μ}_{k}^{*} = \frac{{λ}_{k} - {s}_{k} c}{2} - {\sum }_{j \neq k}^{Φ} {μ}_{j} m < M .$$

As can be seen from the above formula, μ is a polynomial about independent variables λ, which is brought into the main game, and the previous computation is repeated, so that when a first derivative of the utility function of the main game is 0, λ*is recorded as:

$${λ}^{*} = \frac{R + sc}{2} m > M ,$$

$${λ}_{k}^{*} = \frac{R + {s}_{k} c}{2} - β {W}^{2} {\sum }_{j \neq k}^{Φ} {μ}_{j} m < M ,$$

μ* being a local optimal pricing decision and λ* being a local optimal freight volume decision, i.e., decision results of local Nash equilibrium, and also initial values of iteratively computing global Nash equilibrium in the next step.

Specifically, the process of solving decision results of Nash equilibrium according to the gradient descent method includes: initializing pricing decision information of the warehouse, and computing, by the freight vehicle, a freight volume decision of the freight vehicle by the optimal decision model of the freight vehicle according to the pricing decision information of the warehouse; updating a pricing decision of the warehouse using a gradient-assisted search algorithm by the optimal decision model of the warehouse based on the freight volume decision; repeating iteration until the transportation income of the current freight vehicle and a previous round of transportation income are less than the preset threshold; and outputting an optimal freight volume strategy μ* and an optimal pricing strategy λ* at this time.

In some preferred examples, the algorithm operation process of gradient descent algorithm for solving Nash equilibrium includes the following steps.

1. The pricing strategy λ[λᵢ] of a task i is initialized with iteration times k ←1; a threshold ε is preset; where i ∈N, N is the total number of tasks.

2. The freight vehicle decides the freight volume decision μ^{[k]} in the k^{th} iteration according to the pricing strategy of the warehouse requesting party.

3. A gradient-assisted search algorithm is used for warehouse pricing strategy, that is,

$${λ}^{[ k + 1 ]} = {λ}^{[ k ]} + v \frac{\partial {U}_{C}^{[ k ]}}{\partial {λ}^{[ k ]}}$$

is adopted to update the warehouse pricing strategy, v representing the steps of updating the warehouse strategy, and pricing strategy information being sent to all freight vehicle nodes synchronously.

4. The number of iterations is increased by 1, which is expressed as k ←k+1.

5. If

$$\frac{\vert {U}_{c}^{[ k ]} - {U}_{c}^{[ k - 1 ]} \vert}{\vert {U}_{c}^{[ k - 1 ]} \vert} < ε ,$$

enter step 6, otherwise return to step 2.

6. The optimal transportation volume μ*^{[k]} and optimal pricing λ*^{[k]} are outputted.

In the above example, before initialization, the utility functions, that is, the income functions U_{c}, and Uₛ, of two parties need to be inputted. The game leader strategy (the pricing strategy of the warehouse) is initialized, as the starting point of the gradient descent algorithm. ε is a threshold of income change brought by strategy update, as the basis for the exit condition of limited number of iterations. The iterations are repeated between Steps 2-5 until the preset threshold condition in Step 5 exits. The step 2 is to make use of the convex function characteristics of utility function to make the income meet the local optimization, and to obtain a task quantity decision according to a pricing decision. Steps 3-5 represent the specific updating process, where k is the number of iterations. Step 6 outputs the final Nash equilibrium, i.e., the optimal freight volume strategy Wand the optimal pricing strategy λ*.

In some examples, considering that a single freight vehicle can serve multiple freight tasks as well as a single freight task, according to the example of the present disclosure, whether the number of current logistics tasks is greater than 1 can also be determined, if so, the optimal decision model of the freight vehicle can be solved by a direct gradient descent method; and if not, transportation paths are planned by a multi-task freight path algorithm. An execution order of each task is planned under the condition of ensuring the completion of each task within an allowed time to obtain a difference value of shortest paths before and after participating in the task.

Aiming at the problem that a plurality of transport vehicles compete for the same task, a Nash equilibrium solution of a current task for each freight vehicle need to be solved, and the income under each equilibrium condition are ranked to obtain the priority of the task object. By default, the freight vehicle with the highest priority is selected to perform the task.

Considering that the starting point and the target point of multi-task may overlap or the distance may cross and reciprocate, in order to improve the transportation efficiency and solve the vehicle path problem, the present disclosure provides a vehicle path algorithm under multi-task, which plans an execution order of each task under the condition of ensuring the completion of each task within an allowed time to obtain a difference value between total distances before and after adding the task, i.e., the parameter s required by the decision process.

In some preferred examples, the operation process of the multi-task freight path algorithm includes the following steps.

1. A location L₁ of a warehouse i, a location Lⱼ of a freight vehicle j, and a task table Kᵢ, {Kᵢ, j} of the freight vehicle j are inputted.

2. A whole diagram is generated by taking a location of the freight vehicle j as a coordinate origin, taking a starting location L(xᵢ, yᵢ) and an end location L(xⱼ, yⱼ) of the task as vertices, and taking a distance between location coordinates as a weight.

3. A cost matrix arc[n][n] of the diagram is initialized, the cost matrix being one two-dimensional array with a size of n×n.

4. A distance between the freight vehicle j and the warehouse i is computed and stored in the cost matrix, being expressed as \sqrt{(xᵢ-xⱼ)²+(yᵢ-yⱼ)²}=arc[i][j].

5. A first column of the cost matrix is initialized.

6. For any column in the cost matrix, column i=1: n, i being a set of different paths in binary representation.

7. dp[i][0]=arc[i][0].

8. Steps 6-7 are executed.

9. For any line in the cost matrix, line=2ⁿ⁻¹-1.

10. For any column in the cost matrix, i=1: n.

11. When the warehouse i does not belong to a target warehouse set of the freight vehicle j.

12. For any k=1: n.

13. When a warehouse k belongs to the target warehouse set of the freight vehicle j.

14. dp[i][j]=min{arc[i][k]+dp[i][j]-2^{(k-1)},dp[i][j]}.

15. The cycle of steps 13-14 is completed.

16. The cycle of steps 12-15 is completed.

17. The cycle of steps 11-16 is completed.

18. The cycle of steps 10-17 is completed.

19. The cycle of steps 9-18 is completed.

20. sᵢ=d[0][2ⁿ⁻¹−1]-sᵢ₋₁ is outputted.

In the example, the path arrangement is provided for the freight vehicle under multi-tasks, in which the input information is: the task table {K_{i, j}} of the freight vehicle, the starting location and target location of each task and the current location information of the freight vehicle {Lᵢ, Lⱼ}; lines 2-4 generate an n*n two-dimensional array arc, and the values in the array represent the distance length from an i^{th} warehouse to the freight vehicle; lines 5-8 generate a n*2ⁿ⁻¹ two-dimensional array dp, and the value of the first initialized column is equal to the value of the first column of arc; lines 9-19 record the state transition process, and record the weight value with the lowest transition cost into dp matrix; and line 20 outputs sᵢ, i.e., a difference value between the shortest paths before and after participating in the task.

The example of the present disclosure also provides a logistics scheduling system for an industrial park based on a game theory, including road side units, on-board units, mobile edge computing servers, a database platform and an application platform. The road side unit is configured to provide communication support for warehouses and freight vehicles, the on-board unit is configured to locate the freight vehicle, the mobile edge server is configured to provide computing support for a transaction process to realize a logistics scheduling method for an industrial park based on a game theory, and the database and the application platforms is configured to record task transaction information and broadcast task requests.

In the example of the present disclosure, the logistics scheduling system provides task request and task service functions, that is, the warehouse (as the requesting party) requests the freight vehicle (as the serving party) to provide tasks, and the freight vehicle provides freight tasks to the corresponding warehouse.

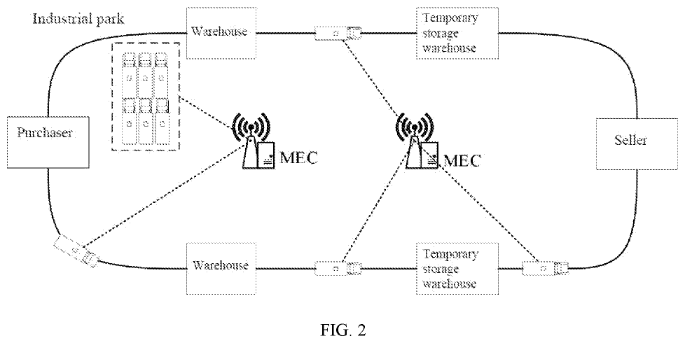

The logistics scheduling task model is shown in FIG. 2. Goods resources need to be transported from suppliers to warehouses, sorted and classified, and transported to production lines of several factories for processing. Finally, finished products are transported to dealers. Medium-sized freight vehicles are responsible for the transportation of goods between warehouses and warehouses, and AGV is responsible for the transportation of goods between temporary storage warehouses within the workshop. In order to meet the communication and data processing between transport vehicles, several road side units and mobile edge computing nodes are set up in the transport section.

In the example of the present disclosure, all legal units need to be registered in the application platform. These legal units include units demanding transportation tasks, that is, task request units, such as warehouses, the temporary storage warehouses within the workshop, and service units in freight tasks, that is, task service units, such as AGV, large freight vehicles and small freight vehicles.

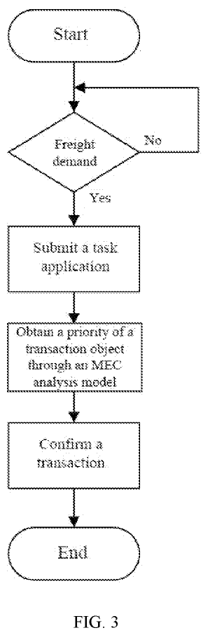

FIG. 3 is a flow chart of a task request according to an example of the present disclosure. As shown in FIG. 3, the process of the task request includes the following steps.

At 201: a warehouse determines whether there is a demand for goods, that is, whether the goods need to be purchased or transported.

At 202: a task application is submitted to a task request unit if there is a demand for goods.

At 203: the logistics scheduling task model is analyzed through the mobile edge computing server, and a priority of the task application in a task queue is obtained. At 204: a transaction is confirmed according to analysis results of the mobile edge computing server.

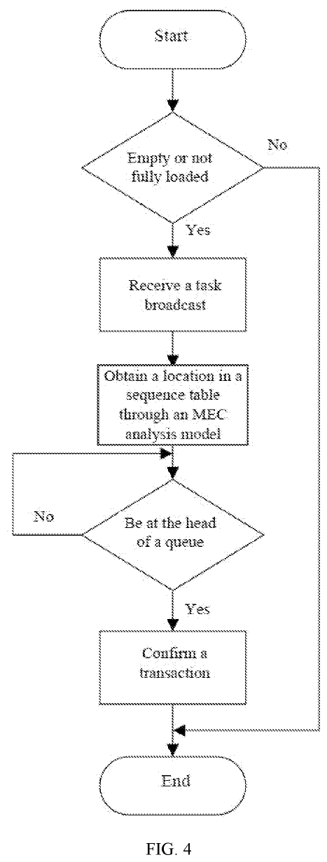

FIG. 4 is a flowchart of task service according to an example of the present disclosure. As shown in FIG. 4, the process of the task service includes the following steps.

At 301: whether the task queue is empty or not fully loaded is determined.

At 302: the broadcasts of task applications submitted by other task request units are received if the task queue is empty.

At 303: the logistics scheduling task model is analyzed through the mobile edge computing server to obtain a location of the task application in the task queue.

At 304: a transaction is confirmed according to analysis results of the mobile edge computing server if the task application is at a topmost location in the task queue.

In some examples, the present disclosure also needs to be implemented after all legal units are registered on the platform, as follows.

At step 1: all legal units in the industrial park are registered into the application platform.

At step 2: each freight task applied by the task request unit is broadcast to all task service units.

The broadcast information is to include a requesting party ID, a task completion deadline T, the mass of the transported goods m, the requesting party location Lᵢ and the target location L of the goods.

At step 3: after receiving the broadcast information, the freight vehicles parked in the parking lot and not fully loaded choose to accept the freight task by default, and the self-information is sent to the adjacent mobile edge computing nodes; the mobile edge computing nodes query the current task table according to various ID information, the freight task preference degree and Nash equilibrium are computed to generate a service unit priority queue of the freight task.

The self-information is to include a serving party ID and a current location Lᵢ.

Table 1 shows the data information needed to compute the subjective preference of the requesting party. Before the mobile edge computing node computes the strategy information of each task, the data information is queried, and the subjective preference of the task is obtained according to the parameters given by the system and proportions of various weights, thereby affecting the final result of the decision.

TABLE 1
Data information needed to compute subjective preferences
of the requesting party

| | Requesting party | Serving party |
|---|---|---|
| Current | L(xᵢ, yᵢ) | L(xⱼ, yⱼ) |
| location | | |
| Number of | f(i, j) | f(i, j) |
| transactions | | |
| Last | f(i, j) | f(i, j) |
| transaction | | |
| time | | |

At step 4: the priority queue is sent to the task request unit, and the freight vehicle at the head of the priority queue is transacted with by default. If the transaction fails or is rejected, it will be made with other freight vehicles according to the priority.

At step 5: after the task transaction is completed, the system automatically records the process information and provides a traceability interface.

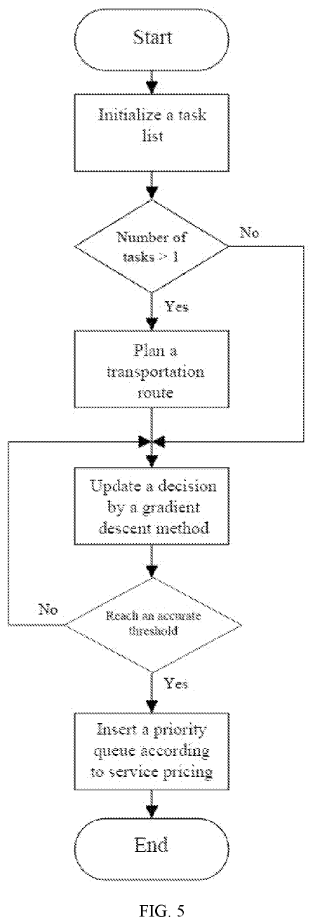

FIG. 5 is a flowchart of strategy analysis after a mobile edge node receives a task according to an example of the present disclosure. The task data processing and Nash equilibrium solution include the following steps.

At 501: the task table of the freight vehicle is queried according to the inputted freight vehicle ID, and the current freight task is added to the task table.

At 502: the starting point and the target point of multi-task may overlap or the distance may cross and reciprocate is considered, in order to improve the transportation efficiency and solve the vehicle path problem, the present disclosure provides a vehicle path algorithm under multi-task, which plans an execution order of each task under the condition of ensuring the completion of each task within an allowed time to obtain a difference value between total distances before and after adding the task, i.e., the parameter s required by the decision process. The specific computing method includes the following steps.

In some preferred examples, the operation process of the multi-task freight path algorithm includes the following steps.

1. A location Lᵢ of a warehouse i, a location Lⱼ of a freight vehicle j, and a task table Kᵢ {K_{i, j}} of the freight vehicle j are inputted.

2. A whole diagram is generated by taking a location of the freight vehicle j as a coordinate origin, taking a starting location L(xᵢ, yᵢ) and an end location L(xⱼ, yⱼ) of the task as vertices, and taking a distance between location coordinates as a weight.

3. A cost matrix arc[n][n] of the diagram is initialized, the cost matrix being one two-dimensional array with a size of n×n.

4. A distance between the freight vehicle j and the warehouse i is computed and stored in the cost matrix, being expressed as \sqrt{(xᵢ-xⱼ)²+(yᵢ-yⱼ)²}=arc[i][j].

5. A first column of the cost matrix is initialized.

6. For any column in the cost matrix, column i=1: n, i being a set of different paths in binary representation.

7. dp[i][0]=arc[i][0].

8. Steps 6-7 are executed.

9. For any line in the cost matrix, line=2ⁿ⁻¹−1.

10. For any column in the cost matrix, i=1: n.

11. When the warehouse i does not belong to a target warehouse set of the freight vehicle j.

12. For any k=1: n.

13. When a warehouse k belongs to the target warehouse set of the freight vehicle j.

14. dp [i][j]=min{arc[i][k]+dp[i][j]-2^{k-1)},dp[i][j]}.

15. The cycle of steps 13-14 is completed.

16. The cycle of steps 12-15 is completed.

17. The cycle of steps 11-16 is completed.

18. The cycle of steps 10-17 is completed.

19. The cycle of steps 9-18 is completed.

20. sᵢ=d[0][2ⁿ⁻¹−1]-sᵢ₋₁ is outputted.

In the example, the path arrangement is provided for the freight vehicle under multi-tasks, in which the input information is: the task table {K_{i, j}} of the freight vehicle, the starting location and target location of each task and the current location information of the freight vehicle {Lᵢ, Lⱼ}; lines 2-4 generate an n*n two-dimensional array arc, and the values in the array represent the distance length from an i^{th} warehouse to the freight vehicle; lines 5-8 generate a n*2ⁿ⁻¹ two-dimensional array dp, and the value of the first initialized column is equal to the value of the first column of arc; lines 9-19 record the state transition process, and record the weight value with the lowest transition cost into dp matrix; and line 20 outputs s sᵢ, that is, a difference value of the shortest path before and after participating in the task.

At 503: according to the distance difference value s obtained in step 502, the utility function of freight vehicles, that is, transportation income, can be accurately defined, which is a quadratic polynomial about independent variables μ. Obviously, the utility function is presented as a convex function in the domain of definition, that is, there is a maximum value of the function, so that the solution of the sub-game is μ whose function is equal to the maximum value. At 504: the follower's decision is used to reverse the leader's decision, and iteration is performed sequentially; iterative updating refers to the process that the strategy maximizes the utility function of the leader, and the strategy is updated according to the first derivative of the utility function; a local optimal solution can be obtained from the utility function; after receiving the freight volume strategy of the freight vehicle, the warehouse makes a new round of pricing strategy, and then the freight vehicle makes a new strategy according to this strategy; iteration is repeated until Nash equilibrium is reached. The specific computing method includes the following steps.

1. The pricing strategy λ[λᵢ] of a task i is initialized with iteration times k ←1; a threshold ε is preset; where i ∈N, N is the total number of tasks.

2. The freight vehicle decides the freight volume decision μ^{[k]} in the k^{th} iteration according to the pricing strategy of the warehouse requesting party.

3. A gradient-assisted search algorithm is used for warehouse pricing strategy, that is,

$${λ}^{[ k + 1 ]} = {λ}^{[ k ]} + v \frac{\partial {U}_{C}^{[ k ]}}{\partial {λ}^{[ k ]}}$$

is adopted to update the warehouse pricing strategy, ν representing the steps of updating the warehouse strategy, and pricing strategy information being sent to all freight vehicle nodes synchronously.

4. The number of iterations is increased by 1, which is expressed as k ←k+1.

5. If

$$\frac{\vert {U}_{c}^{[ k ]} - {U}_{c}^{[ k - 1 ]} \vert}{\vert {U}_{c}^{[ k - 1 ]} \vert} < ε ,$$

enter step 6, otherwise return to step 2.

6. The optimal transportation volume μ*^{[k]} and optimal pricing μ*^{[k]} are outputted.

In the above example, before initialization, the utility functions, that is, the income functions U_{c}, and Uₛ, of two parties need to be inputted. The game leader strategy (the pricing strategy of the warehouse) is initialized, as the starting point of the gradient descent algorithm. ε is a threshold of income change brought by strategy update, as the basis for the exit condition of limited number of iterations. The iterations are repeated between Steps 2-5 until the preset threshold condition in Step 5 exits. The step 2 is to make use of the convex function characteristics of utility function to make the income meet the local optimization, and to obtain a task quantity decision according to a pricing decision. Steps 3-5 represent the specific updating process, where k is the number of iterations. Step 6 outputs the final Nash equilibrium, i.e., the optimal freight volume strategy Wand the optimal pricing strategy λ*.

At 505: the decision information when the precise threshold is reached through a limited number of iterations, is the Nash equilibrium; the mobile edge computing node is configured to record the utility function value of the current requesting party, and according to this value, all the serving party IDs participating in the game are recorded in descending order, and this queue is the priority of goods transportation.

After a round of computing by the mobile edge nodes, the freight vehicles participating in the service competition have determined a task table, a task execution order and a service object, and the warehouses have also determined request objects, and completed the scheduling task of system planning regularly and quantitatively. Therefore, according to a logistics management and scheduling method and system for an industrial park of the present disclosure, the transportation efficiency is improved, a unified management platform is established, and the safety and traceability of goods are guaranteed to a certain extent, which has good practical significance and application value.

In the description of the present disclosure, it is to be understood that the azimuth or positional relationship indicated by the terms “coaxial”, “bottom”, “one end”, “top”, “middle”, “other end”, “upper”, “one side”, “inner”, “outer”, “front”, “center”, and “two ends” is based on the azimuth or positional relationship shown in the attached drawings, which is only to facilitate to describe the present disclosure and simplify the description, and does not indicate or imply that the referred device or element must have a specific direction, be constructed and operated in a specific orientation. Therefore, it is not to be understood as a limitation of the present disclosure.

In the present disclosure, unless otherwise expressly stated and limited, the terms “mount”, “arrange”, “connect”, “fix”, “rotate” are to be understood in a broad sense, for example, the “connect” may be fixedly connected, detachably connected, integrally connected, mechanically connected, electrically connected, directly connected, or indirectly connected through an intermediary, or a communication between two elements or an interaction between two elements. Unless otherwise explicitly defined, for those ordinarily skilled in the art, the specific meanings of the above terms in the present disclosure can be understood according to specific situations.

While examples of the present disclosure have been shown and described, it will be understood by those skilled in the art that various changes, modifications, substitutions and alterations may be made herein without departing from the principles and spirit of the present disclosure, the scope of which is defined by the appended claims and equivalents thereof.

1. A logistics scheduling method for an industrial park based on a game theory, comprising:
modeling warehouses and freight vehicles by a Stackelberg game model according to a relationship between the warehouses and the freight vehicles in logistics tasks, and establishing a logistics scheduling task model according to attributes of the logistics tasks;
solving transportation income of the freight vehicles and warehousing income of the warehouses corresponding to the logistics tasks under various decisions according to a task decision basis in the logistics scheduling task model,
a computing method of the transportation income of the freight vehicles comprising the following steps:
requiring a plurality of freight vehicles to cooperate to complete a task if carrying capacity M of a current freight vehicle is less than freight volume m of a warehouse, the transportation income of the freight vehicles being expressed as:
Uₛ=μᵢλᵢ-sᵢc-β(μᵢW)²
serving a plurality of warehouses by the freight vehicle at the same time if carrying capacity M of a current freight vehicle is greater than freight volume m of a warehouse, the transportation income of the freight vehicle being expressed as:
$${U}_{s} = {\sum }_{i ∈ Φ}^{Φ} {μ}_{i} {λ}_{i} - {\sum }_{i ∈ Φ}^{Φ} {s}_{i} c - {β ( {\sum }_{i ∈ Φ}^{Φ} {μ}_{i} W )}^{2}$$
Uₛ representing the transportation income of the freight vehicle, μᵢ representing freight volume of the freight vehicle performing a task i, λᵢ representing the pricing of the freight vehicle performing the task i, Φ representing the number of logistics tasks that the current freight vehicle needs to perform, c representing the cost per unit mileage of the freight vehicle during freight transportation, sᵢ representing a distance from a starting point to an end point of the freight vehicle performing the task i, β being a state-related parameter that indicates a ratio of current workload to maximum bearing workload, and W being a depreciation rate of the freight vehicle during transportation;
constructing an optimal decision model of each freight vehicle to maximize the transportation income, and constructing an optimal decision model of each warehouse to maximize the warehousing income;
determining whether the number of current logistics tasks is greater than 1, if so, transportation paths being planned by adopting a multi-task freight path algorithm; planning an execution order of each task under the condition of ensuring the completion of each task within an allowed time to obtain a shortest path to participate in the task; generating an initial matrix diagram by taking a location of the freight vehicle as a coordinate origin, taking starting and termination locations of each task as vertices, and taking a distance between the vertices and the coordinate origin as a weight; traversing each vertex, and assigning weight values of vertices that do not belong to a vertex set, by representing each vertex set V in binary based on a dynamic programming algorithm, to generate a two-dimensional array of distance weight values; and traversing all vertices in the vertex set, and updating the weight values in the array according to a state transition equation, a value in a last column of a first row in the array being a shortest path of a current task, and a difference value between the value and a shortest path before receiving the task being a distance from the starting point to the end point of the freight vehicle performing the task i; and
solving the optimal decision model of the freight vehicle according to a gradient descent method, outputting a solution result to the optimal decision model of the warehouse, and iterating two optimal decision models until a preset threshold is reached to obtain optimal decisions of the freight vehicles and the warehouses for logistics scheduling, i.e., decision results of Nash equilibrium.

2. The logistics scheduling method for an industrial park based on a game theory according to claim 1, wherein a computing method of the warehousing income of the warehouses is expressed as:
U_{c}=(Rμᵢ-λᵢ)ω;
U_{c} representing the warehousing income of the warehouse, R representing the income generated by transporting goods per unit to the warehouse, μᵢ representing freight volume of the freight vehicle performing a task i, λᵢ representing the pricing of the freight vehicle performing the task i, and ω representing a subjective preference of the warehouse for the freight vehicle.

3. The logistics scheduling method for an industrial park based on a game theory according to claim 2, wherein the subjective preference of the warehouse for the freight vehicle is obtained by performing weighted sum on a familiarity weight between the freight vehicle and the warehouse, a time weight between the freight vehicle and the warehouse, and a similarity weight between the freight vehicle and the warehouse.

4. The logistics scheduling method for an industrial park based on a game theory according to claim 1, wherein the process of solving the decision results of Nash equilibrium according to the gradient descent method comprises the following steps:
initializing pricing decision information of the warehouse, and computing, by the freight vehicle, a freight volume decision of the freight vehicle by the optimal decision model of the freight vehicle according to the pricing decision information of the warehouse; updating a pricing decision of the warehouse using a gradient-assisted search algorithm by the optimal decision model of the warehouse based on the freight volume decision; repeating iteration until the transportation income of the current freight vehicle and a previous round of transportation income are less than the preset threshold; and outputting an optimal freight volume strategy μ* and an optimal pricing strategy λ* at this time.

5. The logistics scheduling method for an industrial park based on a game theory according to claim 1, further comprising: solving a Nash equilibrium solution of the current task for each freight vehicle when the plurality of freight vehicles compete for a same logistics task, ranking the income under each equilibrium condition to obtain a priority of a task object, and selecting a freight vehicle with a highest priority to perform the task.

6. A logistics scheduling system for an industrial park based on a game theory, comprising road side units, on-board units, mobile edge computing servers, a database platform and an application platform, the road side unit being configured to provide communication support for warehouses and freight vehicles, the on-board unit being configured to locate the freight vehicle, the mobile edge computing server being configured to provide computing support for a transaction process to realize a logistics scheduling method for an industrial park based on a game theory according to claim 1, and the database and the application platforms being configured to record task transaction information and broadcast task requests.
